(19) United States
(12) Patent Application Publication
(10) Pub. No.: US 2010/0259861 A1
(43) Pub. Date: Oct. 14, 2010

(54) Solenoid drive method that conserves power

(75) Inventor: Jeff Maurice Wendt, Lander, WY (US)

Correspondence Address: Douglas P. Etsinger PE,;Pertech Resources, Inc., 860 College View Drive, Riverton, WY, 82501, US

(73) Assignee: Pertech Resources, Inc., Riverton, WY (US)

(21) Appl. No.: 12/384,825

(22) Filed: Apr. 10, 2009

(51) Int. Cl. H01H 47/00; B41J 2/00

(52) U.S. Cl. 361/160; 347/110

(57) ABSTRACT

A drive method for an impact-printhead solenoid is provided that improves power efficiency with an extremely simple circuit configuration and no sensors. Consisting only of a power-FET (Field-Effect Transistor) and PWM (pulse-width-modulation) signals from a printer-controller, this system, using a novel PWM frequency-optimization technique, reduces printhead power usage by as much as 13%.

### CROSS-REFERENCE TO RELATED INVENTIONS

Not Applicable

### STATEMENT REGARDING FEDERALLY SPONSORED RESEARCH OR DEVELOPMENT

Not Applicable

### REFERENCE TO SEQUENCE LISTING, OR A COMPUTER PROGRAM LISTING COMPACT DISC APPENDIX

Not Applicable

### BACKGROUND OF THE INVENTION

This invention relates to power-saving techniques applied to electronic solenoid-drive circuits, and specifically relates to power saving in an impact printer that uses solenoid-driven print-wires under the control of a microcontroller.

Solenoids that convert electrical energy to mechanical movement are well known and can be found in hundreds of varieties. Relays, water-valves, automobile starter solenoids are just a few examples. Also numerous are the means that operate the solenoids. Electromechanical relays were state-of-the-art before solid-state devices entered the scene with lower cost and more efficiency. In recent decades, the electronic circuits driving the solenoids have become more and more sophisticated. The use of microcontrollers and fast-switching transistors have improved even more the precision and efficiency of solenoid actuators.

In the field of impact printheads and printers, it is common to provide a number of identical print wire actuators, commonly in a 9 or 24 wire dot matrix, all driven under microcontroller control. It is well known that the print wires were accelerated into an inked-ribbon, which then placed dots arranged as characters and numbers onto a printed page. Two predominant types of actuators exist:
a. A magnetically driven hammer or clapper, comprising the frame or armature of a solenoid, strikes and accelerates a print-wire, and,
b. A magnetically driven plunger inside the core of a solenoid, attached to a print wire, accelerates a print wire.

In either type, the electrical circuits were similar, and, efforts to conserve energy were very similarly applied, whether the circuit was organized as a constant-current type or as a constant voltage type. The former type offered the best control but was also the most expensive to implement. PWM techniques improved the designs even more, offering a constant-current solution without the expense, especially enabling a more conservative use of energy in the printhead, which is the largest consumer of energy in an impact printer. In fact, the heat created because of wasted energy in an impact printhead and the drive circuits has forced limits on the print-head's print speed. The limits are needed to prevent component failure. Earlier impact printers were forced to run slower or were forced to go into “slowdown” modes when temperatures reached upper limits. Consequently, extra sensors were required to monitor temperatures or print-speeds. This imposes an undesirable performance limitation on a printing system that is often marketed on throughput. Additionally, because of other earth-global issues, energy conservation in product design has become paramount. As a result, a number of energy-conserving techniques exist in the prior art. A number of patents and other documents cite the recycling of flyback energy, created when a solenoid is turned off, back into the power supply, or, to a storage device for reuse. However, there is untapped flyback energy to be saved in another area, which is the focus of this invention.

### BRIEF SUMMARY OF THE INVENTION

The object of this invention is to present an additional and novel method, without extra electronic or mechanical components, to significantly reduce wasted energy in a solenoid actuator system. This method can be applied in any application where a solenoid-operated device, using PWM techniques to control current, is used. The preferred embodiment, a printer with an impact dot-matrix printhead, is summarized and described in detail. This invention improves on the pulse-width current control by optimizing it. There is no claim or discussion in this invention regarding any processing of or redirection of the flyback energy pulse appearing at 1b, FIG. 5, or, at 1d, FIG. 6.

FIG. 1 comprises the few hardware components necessary to operate one of “n” solenoid-actuated print wires in a dot-matrix printhead. A frequency/duty-cycle specific PWM signal, FIG. 4, is applied at 4, FIG. 1. The frequency and duty-cycle are described mathematically in the following paragraphs, and refined empirically at the product design level, after the selection of circuit components, namely, the solenoid drive FET 8. The selected FET's data-sheet reveals its gate capacitance 8a. This value is then used to set the PWM signal's on and off times, and this value should be fine-tuned for real world applications. This gate capacitance, in conjunction with the inductance of the print wire actuator coil and the finite resistance inherent to the circuit, creates a configuration which may best be modeled with 2^{nd}-order differential equations, FIG. 8, yielding an exponential, sinusoidal damping effect on the current flowing through the solenoid.

### BRIEF DESCRIPTION OF THE SEVERAL VIEWS OF THE DRAWING

FIG. 1 Circuit Diagram of the preferred embodiment of the solenoid drive.

FIG. 2 Small-Signal, Equivalent Circuit Model of the preferred embodiment.

FIG. 3 General equation for current flow through a MOSFET device.

FIG. 4 PWM waveform detail and truth table of AND-gate device.

FIG. 5 Illustration of non-optimized waveforms at numbered circuit nodes.

FIG. 6 Illustration of optimized waveforms at numbered circuit nodes.

FIG. 7 Exaggerated View of Ip and exponential decay overlay.

FIG. 8 Solution Equations

### DETAILED DESCRIPTION OF THE INVENTION

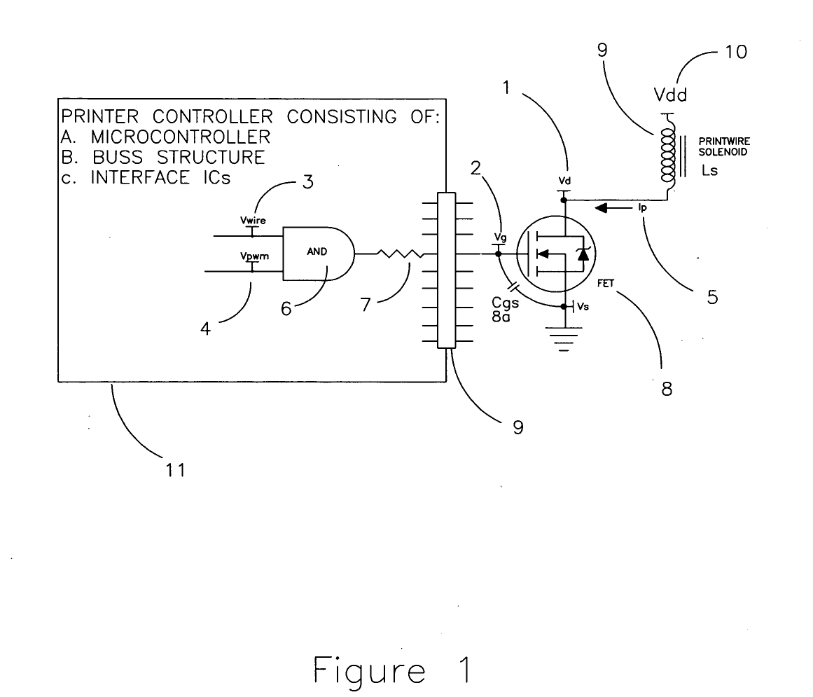

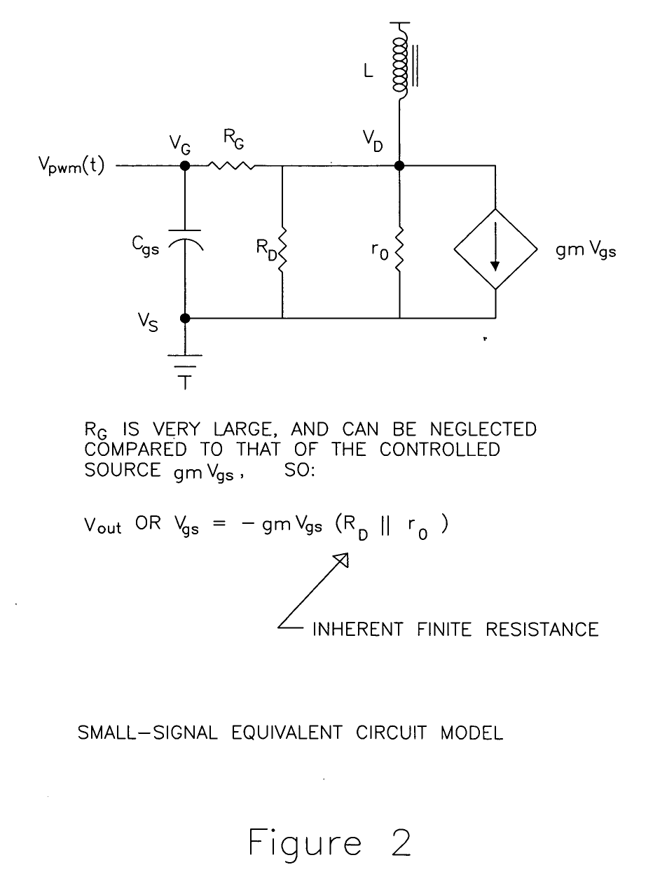

FIG. 1 is the schematic diagram of the preferred embodiment, and shows only the components required of this invention. FIG. 2 is the small-signal equivalent-circuit model of FIG. 1 that sets up the mathematical solution. Circuit variations can occur without deviating from the spirit of the invention. For example, other components and signals, some described previously as prior art, can be added to further enhance the power efficiency or adapt to other applications. This narrative will apply to the preferred embodiment, a dot-matrix impact printer. The circuit has a power input 10, solenoid 9, N-channel power-MOSFET 8, and printer-controller 11. Only the required parts of the printer-controller are shown, such as the logic AND-gate 6, FET gate-current limiting resistor 7, and input signals Vwire 3, Vpwm 4. Connector 9 represents one of multiple circuit connections to a dot-matrix printhead, which often has 9, 12, 24, or more, duplicate solenoid circuits.

Power input 10, often 24 vdc, but not a critical voltage to this invention, provides the potential to operate the solenoid. The printer-controller operates at 3.3 vdc in this embodiment, but this value is not critical to this invention.

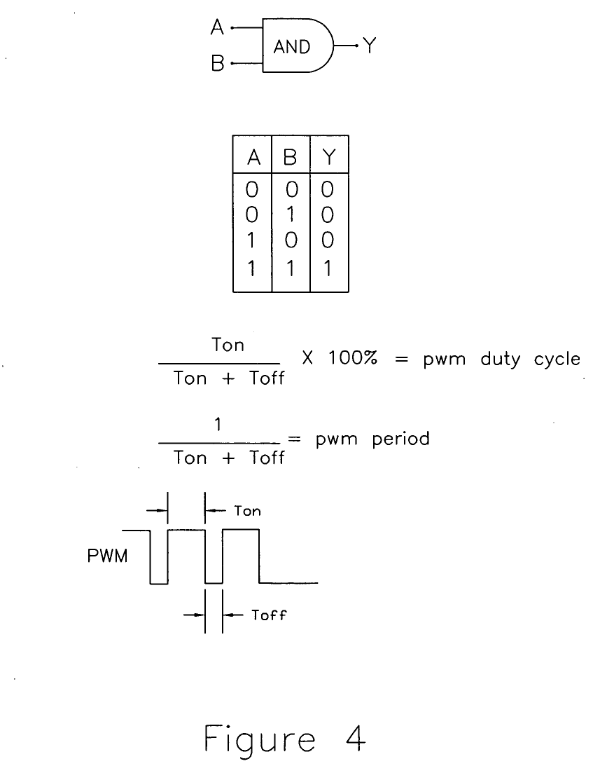

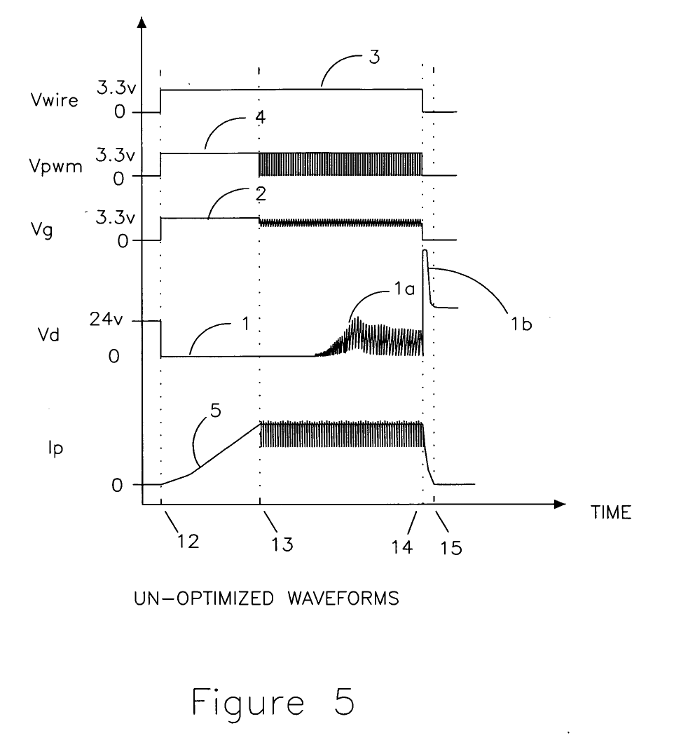

Noting FIG. 1, the printer controller 11 controls energization of the circuit. One of “n” print wires is selected by placing a logic1 signal at 3 along with a logic1 signal at 4. The AND gate 6 turns on and off in conformance with its truth table FIG. 4, and presents its signal 2 at the gate of FET 8 through resistor 7. Those familiar with the art of digital systems will readily see that a logic1 is +3.3 vdc in this embodiment, and logic0 is zero volts. A positive gate voltage at 2 will turn on the FET 8 causing current Ip 5 to flow from the power supply 10, through solenoid 9, and through FET 8 to ground. Noting FIG. 5, the signal 4 is steady in the on state until time 13, where it changes to a pulse-width-modulated (PWM) signal. Ideally, this PWM waveform will be transmitted from the AND-gate 6 to the FET 8 in real time. However, due to the capacitance of the FET gate as well as the capacitance of the AND gate itself, Vg FIG. 1 will follow the established equations for voltage and capacitance. See FIG. 2.

FIG. 5 illustrates the actual voltage levels as they appear un-optimized at nodes 1,2,3,4, and the un-optimized print wire solenoid current Ip at node 5. 1a shows lost power as flyback voltage, typically dissipated as heat somewhere in the circuit.

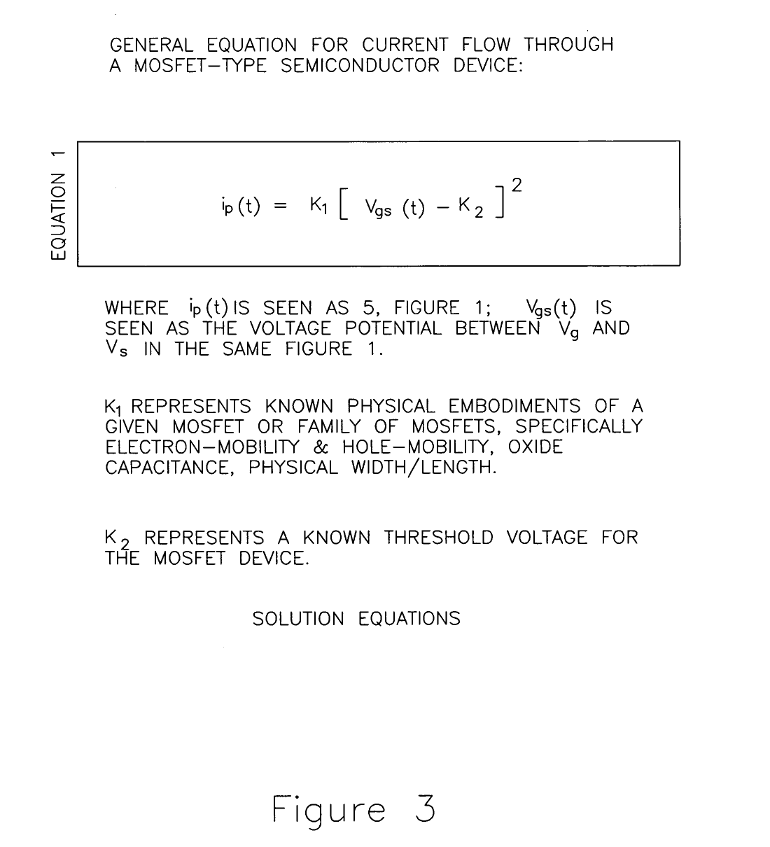

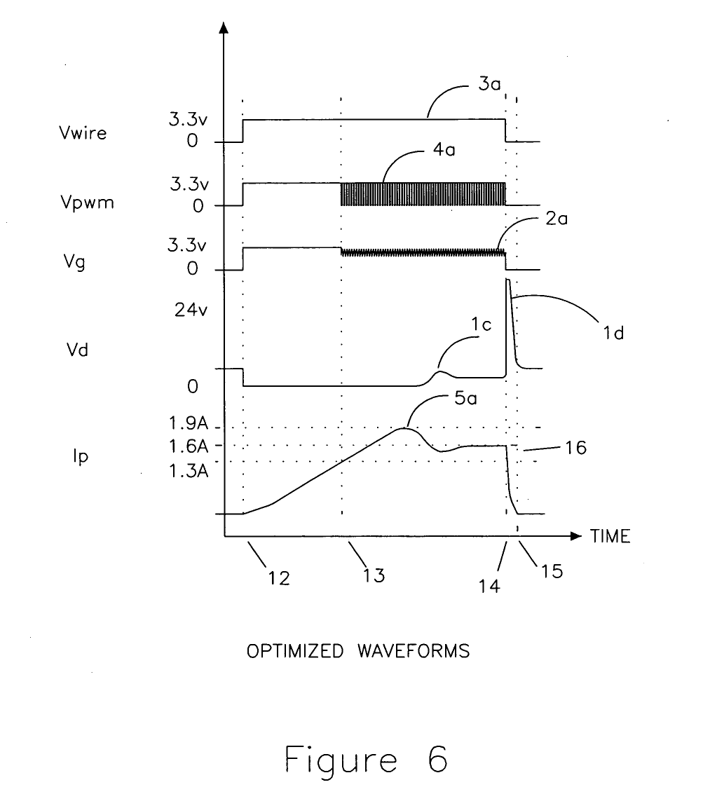

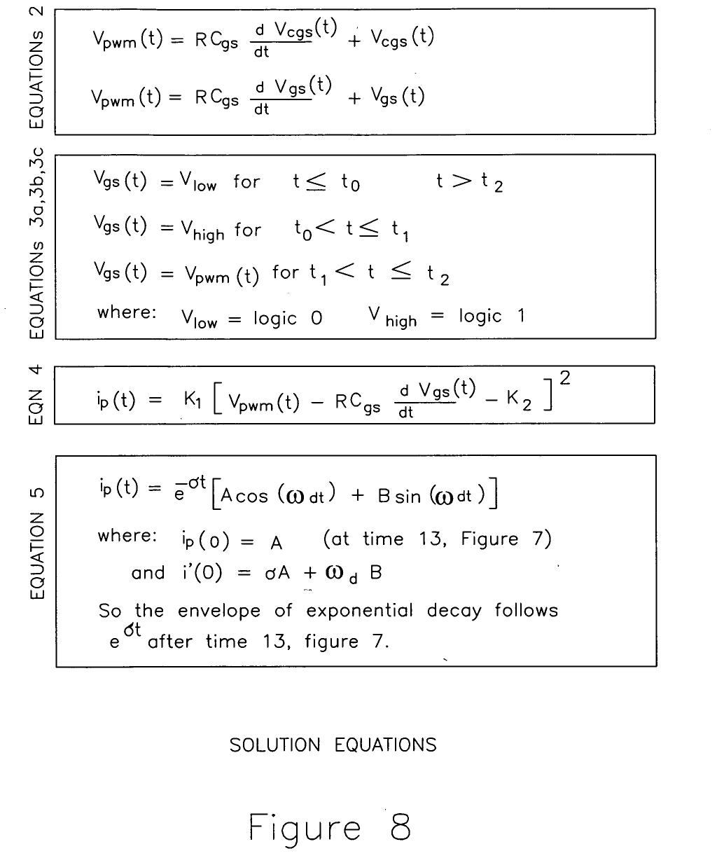

FIG. 6 illustrates the waveforms after optimization, which are the subject of this invention, and described as follows: Viewing FIG. 5 at time 12, the circuit becomes energized. Logic1 at both nodes 3 and 4 cause the level at node 2 to also rise to a logic1 level. As a result, FET 8 then turns on, effecting a very low resistance between node 1 and ground. Again viewing FIG. 5, as the circuit is full-on, current 5 rises quickly in the solenoid, in accordance with equation 1 FIG. 3 and equation 3b FIG. 8. As detailed in the prior art, the print hammer (clapper), being moved by the rising magnetic field, is accelerating the print-wire. At approximately time 13, the solenoid has reached saturation and max. magnetic field, and a PWM signal 4 is applied to control Ip from rising higher, effecting a “constant current” between time 13 and time 14. Also, during the same period from time 13 to time 14, the FET drain-voltage Vd at waveform 1a, FIG. 5, appears. This is solenoid flyback energy appearing across the FET at PWM frequency. Measured waveforms at 1a and 5, FIG. 5, confirm empirically what is already well-known, that, driver-circuits that employ constant-current drives, or use PWM to approximate constant-current drives, will cause a resultant power dissipation to move from the solenoid to the FET and manifest itself as heat, and, obviously, wasted energy. The thermal mathematics will not be addressed, here.

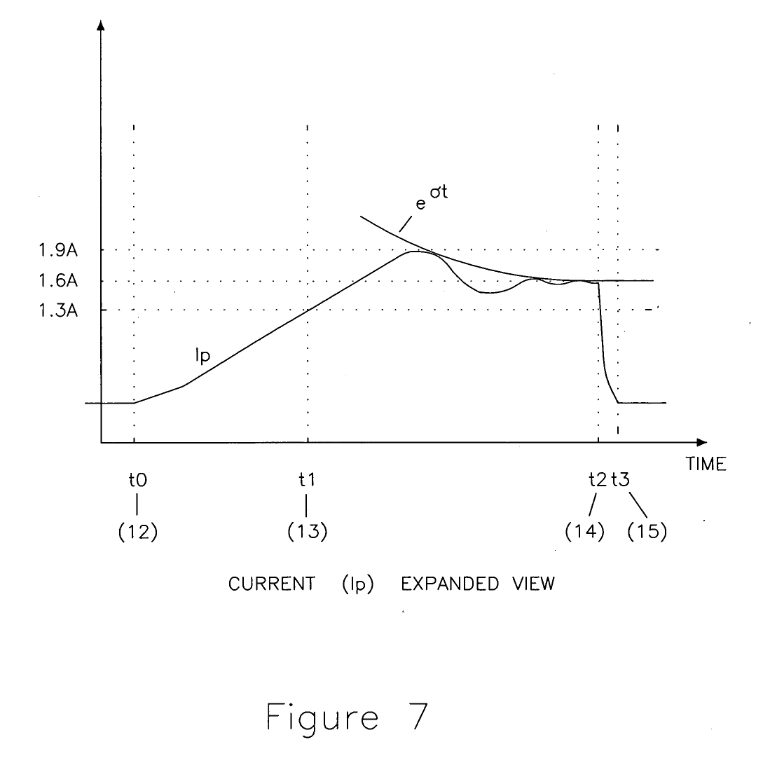

It will be shown that the mathematics, verified with empirical observations, prove that the PWM signal can be adjusted to a point where the circuit still maintains a constant average Ip, yet, eliminates the flyback energy from dissipating across the FET 8 at 1a, FIG. 5. The period and duty-cycle of this PWM signal are such that the net effect on current Ip is that it becomes an exponentially decaying sinusoid, seeking a steady-state optimal value, in this case 1.6 amperes, at 16, FIG. 6. This is also shown in FIG. 7. as an exaggerated view of Ip with its decaying sinusoid shape, described by equation 5, FIG. 8, based in part on equations 1 through 4.

A short discussion of semiconductor specifications is necessary to complete the described technique: All semiconductor devices have specified in their data-sheets parameters of voltage, current, capacitance, frequency limits, and numerous operating limits, all of which enable the designer to accomplish a circuit that works to his needs. Reference FIG. 2, the small-signal equivalent circuit model. In this invention, the designer, having selected a drive-transistor, in this case a particular MOSFET, uses its gate capacitance, by applying a high frequency PWM signal, to limit the device's turn-on and turn-off, therefore producing a smoother waveform. Specifically, the gate-capacitance in combination with the inductance of the solenoid-coil combined with the power-FET's real world resistance establishes a physical reality which can be modeled by second order differential equations in FIG. 8, yielding an exponentially damped sinusoid. Compare waveform 5, FIG. 5 to waveform 5a, FIG. 6.

When the solenoid has exhausted its ability to effect additional acceleration of the wire, the solenoid is shut off at time 14. This shutoff at time 14 is well described in prior art and is not part of this description. The large pulse 1b and 1d appearing at time 14 to time 15 is the flyback energy created from the magnetic field collapse during solenoid shutoff. As indicated, the recovery and reuse of this particular flyback energy pulse is also well described in prior art and is not part of this description.

I claim:

1. An energy-saving solenoid-drive circuit and method comprising: a power supply, a switch means, a solenoid, and a controller to repetitively energize the circuit and solenoid.

2. The energy-saving solenoid-drive circuit of claim 1, where the switch means is a power-FET.

3. The energy-saving solenoid-drive circuit of claim 1, where the switch means, and solenoid are one of a multiplicity of print-wire driver-circuits and solenoids, as in an impact printhead.

4. The energy-saving solenoid-drive circuit of claim 1, where the controller is a microcontroller and part of an impact printer's main control system.

5. The energy-saving solenoid-drive circuit and method of claim 1, where the controller provides pulse-width modulated signals to the circuit and solenoid, the period and frequency of which are pre-determined mathematically, then, refined empirically, through modeling of the terminal parameters of the semiconductors and inductor in the solenoid drive circuit, such that flyback energy from the on and off conditions of the solenoid, is reduced significantly.
